(19) United States
(12) Patent Application Publication
(10) Pub. No.: US 2014/0037402 A1
(43) Pub. Date: Feb. 6, 2014

(54) TRAY SEALER

(71) Applicant: Multivac Sepp Haggenmuller GmbH & Co. KG, Wolfertschwenden (DE)

(72) Inventors: Lars Ickert, Kempten (DE); Christoph Wagner, Ottobeuren (DE)

(73) Assignee: Multivac Sepp Haggenmuller GmbH & Co. KG, Wolfertschwenden (DE)

(21) Appl. No.: 13/956,572

(22) Filed: Aug. 1, 2013

(30) Foreign Application Priority Data
Aug. 3, 2012 (DE) 102012015401.1

(51) Int. Cl. B65G 47/90

(52) U.S. Cl. CPC B65G 47/90
USPC 414/226.02

(57) ABSTRACT

The invention relates to a tray sealer comprising a gripper system configured to tilt trays by means of a tray gripper so as to lift the trays off a collecting belt for conveying them into a sealing station.

### CROSS-REFERENCE TO RELATED APPLICATIONS

This Application claims priority to German Application Number 102012015401.1 filed Aug. 3, 2012, to Lars Ickert and Christoph Wagner entitled “Tray Sealer,” currently pending, the entire disclosure of which is incorporated herein by reference.

### FIELD OF THE INVENTION

The invention relates to a tray sealer.

### BACKGROUND OF THE INVENTION

DE 10 2008 030 510 A1 discloses a tray sealer of the type in question, comprising a gripper system for positioning trays, which are fed on conveyor belts on a single track, on a collecting belt such that they can be grasped by tray grippers on both sides so as to transfer them into a sealing device. The tray grippers grasp a group of trays on both sides and push them into the sealing device. The friction of the tray bottom on the conveyor belt and the friction in the sealing device on supporting disks and a tray reception unit influence the trays here in such a way that they tend to tilt in the conveying direction. This is to be avoided. When different tray heights are used, tray grippers are provided, which are known, for example, from DE 10 2010 014 212 A1 and which have a plurality of vertically extending grooves. This embodiment is complicated and leads to an increased weight and, consequently, increased inertial mass, which has to be highly accelerated and moved.

### SUMMARY OF THE INVENTION

It is the object of the present invention to provide a tray sealer, which allows a conveying of trays that is as independent as possible from friction between the tray bottom and the conveying belt.

The tray sealer according to one embodiment of the present invention comprises a gripper system with two gripper arms for picking up trays so as to remove the trays, for example, from a collecting belt and introducing them into a sealing station, the gripper system being configured to laterally grasp the trays by means of the gripper arms, lift them off the collecting belt and transfer them to the sealing station, each gripper arm comprising tray grippers. The tray sealer is characterized in that the gripper system is configured such that it is able to tilt picked-up trays about a horizontal axis of rotation oriented in the conveying direction. This entails the advantage that, while being conveyed, the trays are not in contact, or at least not in large-area contact with the collecting belt, the discharge belt or parts of the sealing station and that a negative influence caused by friction does therefore not occur.

The gripper system can comprise an electric motor for tilting the tray grippers about the axis of rotation. Adjustment can thus be carried out in a very flexible and dynamic manner so as to allow adaptation of the system to various products, for example, solid, pasty or liquid products.

The axis of rotation for the tilting movement can be an axis of rotation of a rhomboid mechanism, the rhomboid mechanism being configured for moving the gripper arms towards and away from the trays.

According to one embodiment, the rhomboid mechanism includes a lever by means of which the tray gripper can be tilted.

The gripper system may comprise two guide units for the two gripper arms, the guide units being vertically movable by means of an adjustment drive, so as to allow a vertical adjustment of the tray grippers, for example, for adaptation to various tray heights.

The vertical adjustment drive can include eccentrics allowing through their rotation a vertical adjustment of the gripper arm guide units supported therein.

The vertical adjustment drive preferably includes an electric motor, for example, a servomotor, so that the tray grippers can be adjusted dynamically to various heights.

Other and further objects of the invention, together with the features of novelty appurtenant thereto, will appear in the course of the following description.

### DESCRIPTION OF THE SEVERAL VIEWS OF THE DRAWING

In the following, an advantageous embodiment of the present invention will be explained in more detail on the basis of a drawing, in which the individual figures show:

FIG. 1 is a side perspective schematic view of a tray sealer according to one embodiment of the present invention;

FIG. 2 is a side perspective schematic view of a of a tray sealer without its cover according to one embodiment of the present invention;

FIG. 3 is a top perspective schematic view of a of a tray gripper according to one embodiment of the present invention;

FIG. 4a is a sectional view, in the conveying direction, of the gripper system at an open position according to one embodiment of the present invention;

FIG. 4b is a sectional view of the gripper system at a closed position according to one embodiment of the present invention;

FIG. 4c is a sectional view of the gripper system at a tilted position according to one embodiment of the present invention; and

FIG. 5 is a variant of a vertically adjustable gripper system with a tray gripper variant according to one embodiment of the present invention;

Identical components are provided with identical reference numerals throughout the figures.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

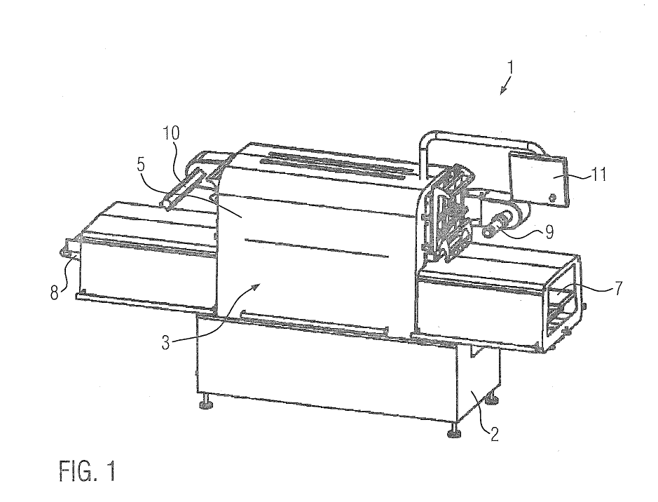

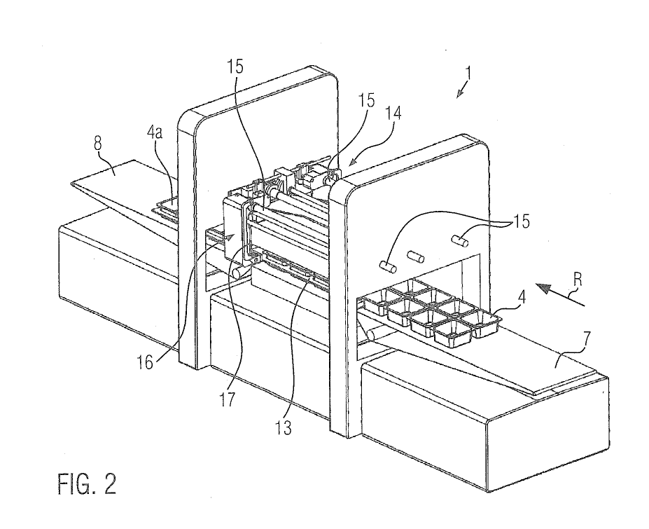

FIG. 1 shows a perspective view of a tray sealer 1. The packaging machine 1 is provided with a machine frame 2 having arranged thereon a sealing device 3 for closing and, if desired, sealing and/or evacuating and/or flushing with gas trays 4 supplied thereto (cf. FIG. 2) as well as for cutting a cover film used for closing, the cover film being not shown. The sealing device 3 is located below a protective cover 5.

The packaging machine 1 may additionally be provided with a feed belt or collecting belt 7 for feeding the trays 4 filled with the product in question, a discharge belt 8 for transporting the closed trays 4a away, a film supply reel 9 for receiving thereon and supplying a cover film, and a residual film winder 10 for winding up the film web of the cover film that remains after sealing. A display 11 enables the operator of the packaging machine 1 to check and control the operation of the packaging machine 1.

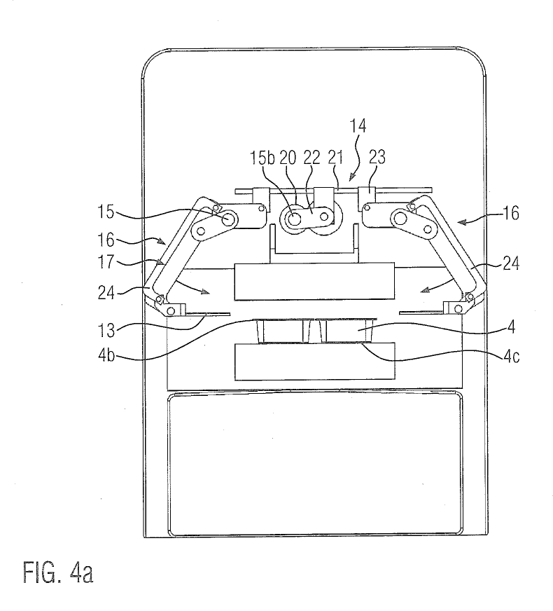

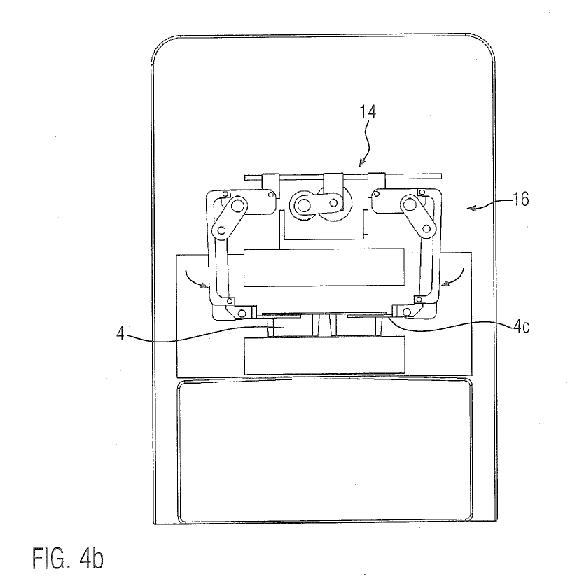

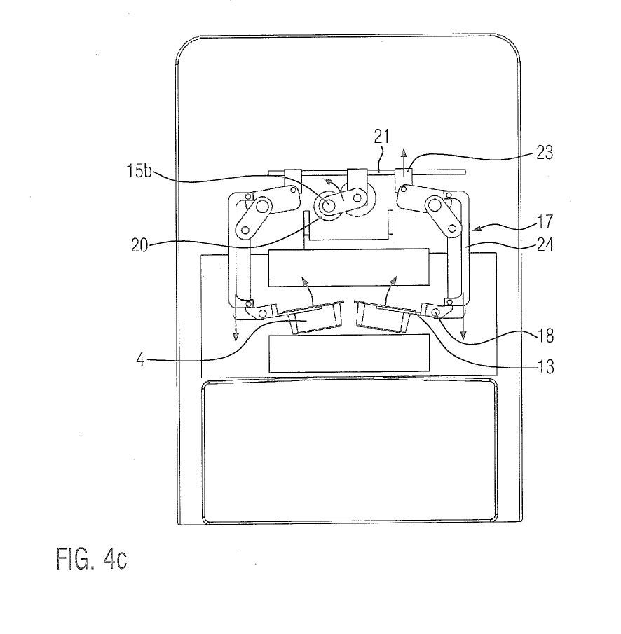

FIG. 2 shows the tray sealer 1 without the protective cover 5. In one embodiment, a gripper system 14 comprises two guide units 15 and a respective gripper arm 16 which is movable along the guide unit 15. The gripper arm 16 may be pivotable about the guide unit 15 and, by means of a rhomboid mechanism 17, the tray gripper 13 can be moved outwards or inwards towards the tray 4. During this movement, the tray gripper orientation parallel to the conveying plane, which is defined by the support plane of the tray bottom 4c (cf. FIG. 4a), can be maintained. The movement of the gripper arms 16 in the conveying direction R and in a direction opposite to the conveying direction R takes place for introducing unsealed trays 4 from the collecting belt 7 into the sealing station 3 and for removing sealed trays 4a from the sealing station 3 station 3 and placing them onto the discharge belt 8.

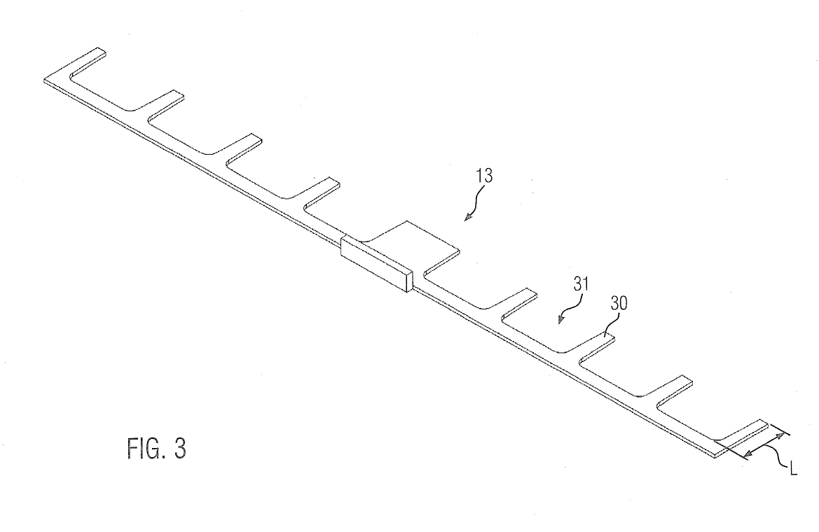

FIG. 3 shows the tray gripper 13 of one of the two gripper arms 16 in accordance with one embodiment. It can have the shape of a rake so that, during a conveying movement, four trays 4 per tray gripper 13 can be moved into the sealing station 3 and four other, previously sealed trays 4a can be removed from the sealing station 3 simultaneously. The prongs 30 can have a length L extending beyond the center of gravity of the tray 4 filled with the product in question, transversely to the conveying direction R below a tray edge 4b (cf. FIG. 4a) of the tray 4, so that the tray 4 can be tilted, in a manner guaranteeing process reliability, by means of the tray gripper 13 such that the tray bottom 4c of the trays 4 raises from the collecting belt 7. Each tray 4, 4a rests on two prongs 30. An abutment side 31 of the tray gripper 13 functions as a stop for an outwardly facing side of the trays 4, 4a and prevents the trays from slipping out of the tray gripper 13 even in the case of high accelerations and speeds.

After tilting, the tray 4 no longer rests on the collecting belt 7 with its entire tray bottom 4c. It would be imaginable that it still rests on the collecting belt 7 along a linear contact area or that it is fully lifted off the collecting belt 7.

FIG. 4a shows the gripper system 14 as a sectional view in the conveying direction R with the gripper arms 16 and the rhomboid mechanism 17 occupying an open position. The gripper arms 16 can pivot inwards about the guide units 15. The pivotal movement may be executed via the rotation of the guide units 15. FIG. 4b shows the gripper arms 16 at a position in which the tray grippers 13 come into contact with the trays 4 and the trays are located between the prongs 30. FIG. 4c shows the gripper system 14 at a tilted position. Here, an electric motor 20, preferably a servomotor, causes by means of a mechanism 22 lifting of a system of levers 21 connected to the parallel kinematics mechanism 17 via elements 23 movable on the system of levers 21. The system of levers 21 is coupled to the gripper arms 16 and moves in the conveying direction R together with the gripper arms along a guide shaft 15b. The electric motor 20 rotates the guide shaft 15b and transmits through the mechanism 22 the movement to the system of levers 21 and the elements 23. Via the change in position of a lever 24 of the parallel kinematics mechanism 17, which executes a downward movement, the tray gripper 13 is tilted and raises the trays 4. The axis of rotation 18, about which the trays 4 are pivoted in the course of this process, is an axis of rotation in the lower area of the parallel kinematics mechanism 17 of the gripper arm 16.

The rotary motion of the guide units 15 of the gripper arms 16 can be combined with the tilting movement by means of the electric motor 20, so that a deflection of the tray grippers 13 with respect to the horizontal position can also be effected during the opening or closing movement of the gripper arms 16.

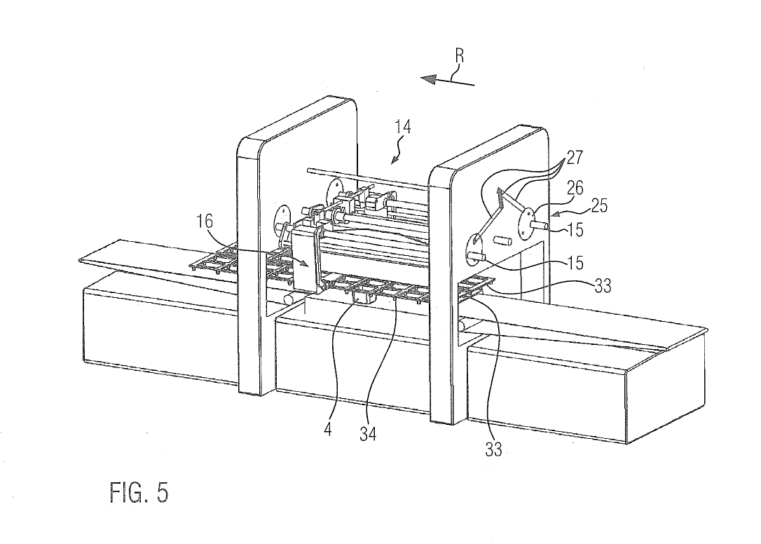

FIG. 5 shows a variant of the gripper system 14 with a vertical adjustment unit 25 used for vertically lifting and lowering the guide units 15. This vertical adjustment unit 25 may be used in addition to the gripper system 14 shown in the above figures or it may be used only in connection with the gripper arm movement along the guide units 15 so as to move the gripper arms 16 into the closed or open position. The guide units 15 can be supported in eccentrics 26 and the eccentrics 26 themselves may be rotated synchronously via the levers 27. The levers 27 can be driven by an electric motor, preferably a servomotor, which is not shown. By means of the vertical adjustment unit 25, a variant of a tray gripper 33 can be used, which is configured such that, while occupying a position above the trays 4, it will push the trays 4 at their tray edge 4b in the conveying direction R. To this end, the tray gripper 33 can have provided thereon catches 34 which are capable of taking hold of the tray edge 4b in the area of the corners or which, when the trays 4 are being pushed, are in contact with the trailing side of the tray edge 4b extending transversely to the conveying direction R. The tray gripper 33 itself prevents here tilting of the tray 4 during the sliding movement, since it defines from above an abutment for the tray edge 4b.

The vertical adjustment unit 25 may be used in combination with the tray gripper 13 according to the preceding figures so as to convey trays 4 having the same tray edge 4b but different tray heights, without any necessity of making modifications on the gripper system 14.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A gripper system for a tray sealer, the gripper system comprising:
two gripper arms for picking up trays so as to remove the trays from a collecting belt and introduce them into a sealing station, the gripper arms being configured to laterally grasp the trays, lift them off the collecting belt and transfer them to the sealing station;
wherein each gripper arm includes tray grippers;
wherein the gripper system is configured such that it is able to tilt picked-up trays about a horizontal axis of rotation oriented in a conveying direction.

2. The gripper system according to claim 1 further comprising an electric motor for tilting the tray grippers about the axis of rotation.

3. The gripper system according claim 1, wherein the axis of rotation is an axis of rotation of a rhomboid mechanism, the rhomboid mechanism being configured for moving the gripper arms towards and away from the trays.

4. The gripper system according to claim 3, wherein the rhomboid mechanism includes a lever by means of which the tray gripper can be tilted.

5. The gripper system according to claim 1 further comprising two guide units for the two gripper arms, the guide units being vertically movable by means of an adjustment drive.

6. The gripper system according to claim 5, wherein the adjustment drive includes eccentrics.

7. The gripper system according to claim 5, wherein the adjustment drive includes an electric motor.
